(19) United States
(12) Patent Application Publication
(10) Pub. No.: US 2016/0006007 A1
(43) Pub. Date: Jan. 7, 2016

(54) BATTERY MODULE

(71) Applicants: SANYO Electric Co., Ltd., Osaka (JP); PANASONIC CORPORATION, Osaka (JP)

(72) Inventors: Hiroshi TAKASAKI, Osaka (JP); Tsuneyuki EJIMA, Osaka (JP)

(73) Assignees: PANASONIC CORPORATION, Osaka (JP); SANYO ELECTRIC CO., LTD., Osaka (JP)

(21) Appl. No.: 14/770,808

(22) PCT Filed: Feb. 27, 2014
(86) PCT No.: PCT/JP2014/001045

§ 371 Date: Aug. 26, 2015

(30) Foreign Application Priority Data
Feb. 27, 2013 (JP) 2013-037422

(51) Int. Cl. H01M 2/10; H01M 10/658; H01M 10/6554; H01M 2/02

(52) U.S. Cl. CPC H01M 2/1094; H01M 2/0277; H01M 10/658; H01M 10/6554

(57) ABSTRACT

Battery module includes the following elements: a plurality of batteries; and metallic or ceramic battery case that includes a plurality of holding parts holding corresponding batteries. Heat insulating member is disposed between wall surface of each of holding parts and corresponding one of batteries. Heat insulating member is disposed in a part between wall surface of holding part and battery so that air layer is formed between wall surface and battery.

### RELATED APPLICATIONS

This application is the U.S. National Phase under 35 U.S.C. §371 of International Patent Application No. PCT/JP2014/001045, filed on Feb. 27, 2014, which in turn claims the benefit of Japanese Application No. 2013-037422, filed on Feb. 27, 2013, the disclosures of which Applications are incorporated by reference herein.

### TECHNICAL FIELD

The present invention relates to a battery module.

### BACKGROUND ART

In the chemical battery, such as a lithium ion battery, abnormal heat generation caused by an internal short circuit, for example, can make the surface of the battery reach high temperatures (e.g. 300° C. to 600° C.). Thus, various safety measures are taken for a battery module including a plurality of batteries.

For instance, Patent Literature 1 discloses the following battery module. When a short circuit state is detected, the positive and negative electrode output terminals are short-circuited by an external short-circuiting measure, such as a relay, to provide a bypass path so that the generated heat is not concentrated inside the module. Patent Literature 2 discloses a battery module in which cooling spacers each filled with a phase-changing medium are arranged in intimate contact with the batteries. The phase-changing medium changes from a solid to a liquid when absorbing heat.

### CITATION LIST

### Patent Literature

PTL 1: Japanese Patent Unexamined Publication No. 2007-141511

PTL 2: Japanese Patent Unexamined Publication No. 2010-192333

### SUMMARY OF THE INVENTION

However, in the technique of Patent Literature 1, when part of batteries generates abnormal heat, the entire system is shut down, and a strong thermal effect is exerted on batteries in a normal state in proximity to batteries in an abnormal heat generation state. The technique of Patent Literature 2 requires a liquid discharging device to prevent contamination caused by the medium whose phase is changed into a liquid. This increases the size of the module.

Namely, an object of the present invention is to provide a battery module that does not have the above problems and is capable of reducing the thermal effect on normal batteries when abnormal heat generation is caused in part of batteries.

A battery module of the present invention includes the following elements: a plurality of batteries; and a metallic or ceramic battery case that includes holding parts holding the corresponding batteries. A heat insulating member is disposed between the wall surface of each of the holding parts and the corresponding one of the batteries. The heat insulating member is disposed in a part between the wall surface of the holding part and the battery so that an air layer is formed between the wall surface and the battery.

In accordance with a battery module of the present invention, a simple structure allows reduction of a thermal effect on normal batteries when abnormal heat generation is caused in part of batteries.

### BRIEF DESCRIPTION OF DRAWINGS

FIG. 1 is an exploded perspective view showing an overall configuration of a battery module in accordance with a first exemplary embodiment of the present invention.

FIG. 2 is a top view showing a battery case that holds batteries in the battery module in accordance with the first exemplary embodiment.

FIG. 3 is a diagram showing part of a section taken along AA line of FIG. 2.

FIG. 4 is a diagram showing a variation of the first exemplary embodiment.

FIG. 5 is a diagram showing another variation of the first exemplary embodiment.

FIG. 6 is a perspective view showing a battery case that holds batteries in a battery module in accordance with a second exemplary embodiment of the present invention.

FIG. 7 is a diagram showing part of a section taken along BB line of FIG. 6.

FIG. 8 is a diagram showing a variation of the second exemplary embodiment.

FIG. 9A is a diagram showing a case where battery T held at an end of the battery case abnormally generates heat in the battery module in accordance with the second exemplary embodiment.

FIG. 9B is a graph showing a relation between peak temperatures on the bottom faces of battery X and battery Y and an inverse number of a thermal resistivity in a holding part that holds battery X when battery T abnormally generates heat.

FIG. 10 is a sectional view of a battery module in accordance with a third exemplary embodiment of the present invention.

### DESCRIPTION OF EMBODIMENTS

Hereinafter, exemplary embodiments of the present invention are demonstrated. The drawings referenced in the exemplary embodiments are schematically illustrated, and dimension ratios of elements illustrated in the drawings may be different from those of actual elements. The specific dimension ratio or the like should be appreciated in consideration of the following description.

In this specification, “substantially **” has the following meaning. For example, “substantially identical” is intended to include not only those “completely identical” but also those recognized as “substantially identical”.

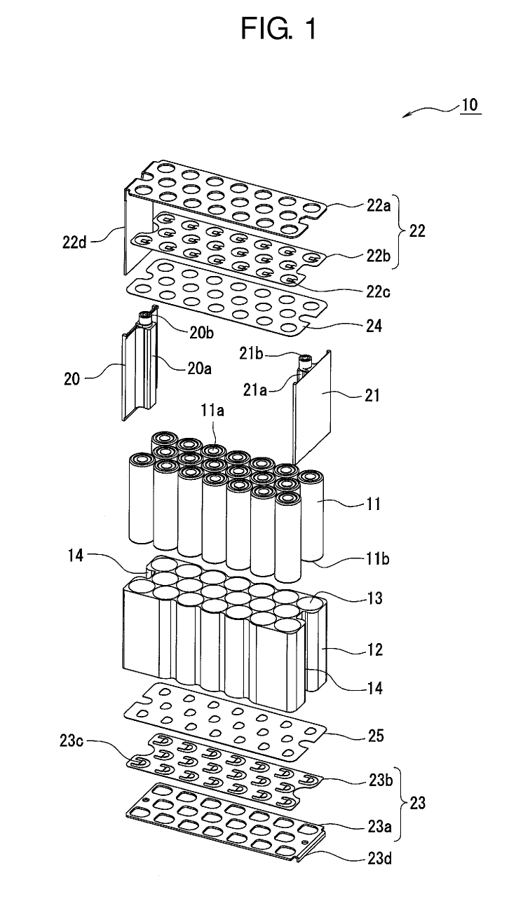

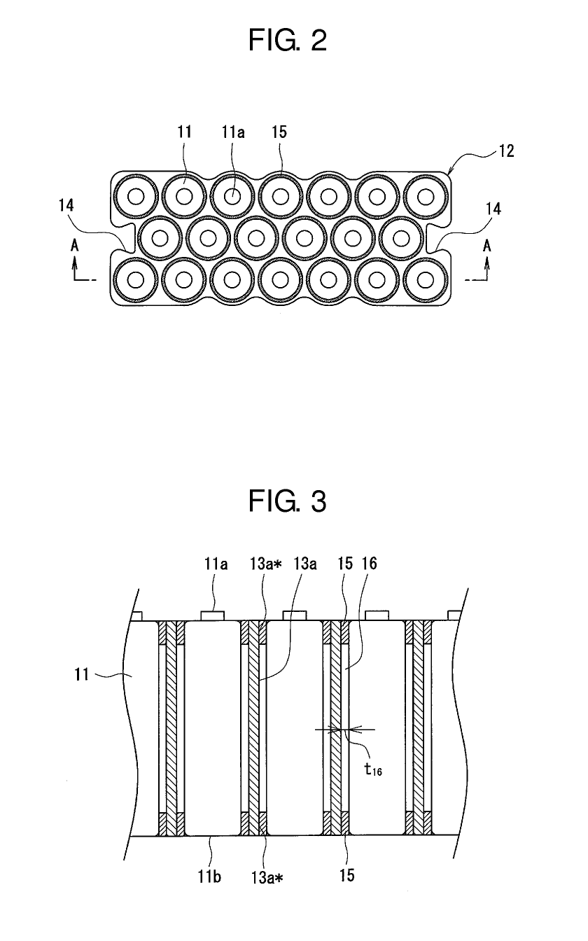

With reference to FIG. 1 through FIG. 10, first through third exemplary embodiments are detailed. Battery 11 in each of the exemplary embodiments is described as a cylindrical battery but not limited to a cylindrical type and may have another form, such as a square type. In the following description, for convenience of explanation, the terms showing directions are used. The direction along the axial direction of battery 11 is defined as a “vertical direction” and the side of positive electrode terminal 11a of battery 11 is defined as a “top”. In FIG. 2, the vertical direction on the plane is defined as a “width direction” of battery case 12, for example, and the horizontal direction on the plane is defined as a “length direction” of battery case 12, for example. (In FIG. 2, the direction perpendicular to the plane is a vertical direction of battery case 12.)

### First Exemplary Embodiment

Each of FIG. 1 through FIG. 3 shows battery module 10 of the first exemplary embodiment.

FIG. 1 is an exploded perspective view showing an overall configuration of battery module 10. FIG. 2 is a top view showing battery case 12 that holds batteries 11. FIG. 3 is a diagram showing part of a section of battery case 12 taken along the axial direction of battery 11 (a section taken along AA line of FIG. 2).

Battery module 10 includes a plurality of batteries 11 and battery case 12 that holds individual batteries 11. Battery case 12 has a block shape having a plurality of through-holes passing through the case in the vertical direction, and the through-holes form a plurality of holding parts 13 holding corresponding batteries 11. In this exemplary embodiment, battery case 12 has a substantially rectangular shape as viewed from the top and is long in the length direction. Battery case 12 has 20 independent holding parts 13, but the number of holding parts 13 is not limited to 20. In battery case 12, plurality of battery cases 13 is arranged along the length direction of the case in lines. Three lines are disposed along the length direction of the case. The central line has six holding parts 13 and the line at each of both ends has seven holding parts 13. Each of holding parts 13 in the central line is formed between two holding parts 13 in the line at each end. Holding parts 13 in adjacent lines are arranged to form a hound's-tooth (a staggered (zigzag)) pattern.

Preferably, recesses 14 for receiving holders 20, 21, which will be described later, are formed in battery case 12. Recess 14 is a groove formed in battery case 12 at each of both ends in the length direction and extending in the vertical direction.

Preferably, each of the through-holes as holding parts 13 is formed into a round hole conforming to the shape of battery 11. Each of the through-holes (holding parts 13) has a diameter (hereinafter being referred to as a “hole-diameter”) slightly larger than that of battery 11, and thus is capable of holding battery 11. In the space between wall surface 13a of holding part 13 and battery 11, heat insulating member 15, which will be described later, is disposed. In this exemplary embodiment, the longitudinal direction (hereinafter being simply referred to as a “length”) of holding part 13 is substantially equal to the axial length of battery 11.

Preferably, battery module 10 has holders 20, 21 to be fixed to battery case 12. Holders 20, 21 are plate-like members having dimensions at which both end faces of battery case 12 in the length direction are covered. Holder 20 has projection 20a formed on one face and holder 21 has projection 21a formed on one face. Holders 20, 21 are disposed opposite to each other with battery case 12 interposed therebetween and projections 20a, 21a facing battery case 12. Projections 20a, 21a have shapes to be fitted into recesses 14 of battery case 12, and are inserted into recesses 14 from the upper side or lower side of battery case 12.

On the top side of battery case 12, positive electrode connecting member 22 connecting positive electrode terminals 11a of corresponding batteries 11 is disposed. On the bottom side of battery case 12, negative electrode connecting member 23 connecting negative electrode terminals 11b of corresponding batteries 11 is disposed. Positive electrode connecting member 22 and negative electrode connecting member 23 are fixed to holders 20, 21, using screws, for example, not shown. Between battery case 12 and positive electrode connecting member 22, plate-like insulating members 24 is disposed. Between battery case 12 and negative electrode connecting member 23, plate-like insulating members 25 is disposed. Each of plate-like insulating members 24, 25 has holes to expose corresponding terminal portions of plurality of batteries 11. Examples of each of insulating members 24, 25 include a substrate in which a glass nonwoven fabric is impregnated with epoxy resin (glass epoxy).

Positive electrode connecting member 22 is preferably a laminate of first plate 22a and second plate 22b. Connecting pieces 22c of second plate 22b are connected to corresponding positive electrode terminals 11a of batteries 11 by welding, for example. First plate 22a has external connecting terminal 22d, which is connected to external connecting terminal 23d on the negative electrode side of adjacent battery module 10, for example. Negative electrode connecting member 23 is also preferably a laminate of first plate 23a and second plate 23b. Connecting pieces 23c of second plate 23b are connected to corresponding negative electrode terminals 11b of batteries 11 by welding, for example. External connecting terminal 23d of first plate 23a is connected to external connecting terminal 22d on the positive electrode side of adjacent battery module 10, for example.

Though not shown, each battery 11 has a gas discharge valve on the side of positive electrode terminal 11a, for example. Though not shown, battery case 12 has a duct on the side of positive electrode terminals 11a. Then, when gas is generated by abnormal heat generation, for example, a high-temperature gas is released through the duct. The gas discharge valve may be disposed on the side of negative electrode terminals 11b. The duct is disposed to cover the gas discharge valves.

Hereinafter, a detailed description is disposed for the configuration of battery case 12, especially for holding parts 13.

Battery case 12 is a battery holding member made of metal or ceramic. Preferably, battery case 12 is configured of metal or ceramic having a thermal conductivity equal to or higher than 150 W/mK. Battery case 12 made of a material having high thermal conductivity can equalize the heat of individual batteries 11 and allows abnormal heat generated in part of batteries 11 to be released to the outside easily. In terms of light weight, material cost, mechanical strength, or the like, in addition to high thermal conductivity, battery case 12 is preferably made of aluminum. Aluminum material includes aluminum alloys containing other metal elements, such as copper, manganese, silicon, magnesium, zinc, and nickel.

In battery case 12, heat insulating member 15 is disposed between wall surface 13a of holding part 13 and battery 11. Heat insulating member 15 may be disposed on battery 11 or disposed on wall surface 13a of holding part 13. Heat insulating member 15 is fixed to wall surface 13a, using an adhesive agent, for example. In the example shown in FIG. 2, heat insulating members 15 are disposed between wall surfaces 13a and batteries 11 in all holding parts 13.

Preferably, heat insulating member 15 has a thermal conductivity lower than that of the material forming battery case 12, is a solid at 300° C., and has a thermal decomposition start temperature equal to or higher than 300° C. The thermal conductivity of heat insulating member 15 is preferably equal to or lower than 1 W/mK. A resin film, such as a polyethylene terephthalate (PET) film, is attached to battery 11 for insulation, but the film does not have the above heat resistance and does not function as heat insulating member 15.

Heat insulating member 15 has the following function. When abnormal heat generation is caused in part of batteries 11, heat insulating member 15 prevents thermal runaway by reducing the thermal effect on other normal batteries 11. In some cases, abnormal heat generation can make the temperature of the surface of battery 11 exceed 300° C. For this reason, heat insulating member 15 needs to exert the insulating function even when being exposed to such high temperatures. Thus, it is necessary for heat insulating member 15 to be a solid at least 300° C., preferably at 400° C., and more preferably at 500° C., and not to be fluidized and to remain between wall surface 13a and battery 11 even at high temperatures.

The thermal decomposition start temperature of heat insulating member 15 is at least 300° C., preferably 400° C. or higher, and more preferably 500° C. or higher. The thermal decomposition start temperature is a temperature at which the weight of heat insulating member 15 starts to decrease when the temperature of heat insulating member 15 is gradually increased, and can be measured using a thermogravimetric/differential thermal analyzer (TG-DTA).

In addition to low thermal conductivity as described above, high heat resistance is required of heat insulating member 15. Thus, the preferable material forming heat insulating member 15 is a material containing highly heat-resistant resin. Such materials include organic and inorganic composite materials, such as glass epoxy as described above, and highly heat-resistant resins, such as polybenzimidazole and polyimide. Preferably, such a resin has a glass transition temperature (Tg) of 300° C. or higher, more preferably 350° C. or higher, and especially preferably 400° C. or higher, and is essentially consists of polyimide. Heat insulating member 15 may be formed of a material having a large number of pores such as foam.

An example of a preferable shape of heat insulating member 15 is a ring shape whose outer diameter is substantially equal to the hole-diameter of holding part 13 and whose inner diameter is substantially equal to the diameter of battery 11. The use of ring-shaped heat insulating member 15 can prevent contact of wall surface 13a with outer circumferential surface of battery 11 in all regions thereof. To support battery 11 in a stable manner and prevent contact with wall surface 13a, heat insulating member 15 is preferably disposed on wall surface 13a (hereinafter being referred to as a “wall surface 13a*”) at least at both longitudinal ends of holding part 13.

Heat insulating member 15 may be disposed so as to cover all regions of wall surface 13a of holding part 13, namely, in all regions between wall surface 13a and battery 11, but is preferable to be disposed in a part between wall surface 13a and battery 11. Thus, air layer 16 can be formed between wall surface 13a and battery 11. Air has a thermal conductivity lower than that of heat insulating member 15; thus, reducing the installation area of heat insulating member 15 and increasing the area of air layer 16 can enhance the heat insulating function.

To support batteries 11 in a stable manner and enhance the heat insulating property at the same time, heat insulating member 15 is especially preferably disposed on wall surface 13a* only. Namely, heat insulating member 15 is disposed on wall surface 13a* only in two positions on the top and bottom. Preferably, the vertical length of heat insulating member 15 is short to an extent in which the battery is supported without any problem. For holding parts 13 for holding a 18650 type cell (with a length of approximately 65 mm), each of heat insulating members has a length of 1 mm to 10 mm preferably, and that of 1 mm to 5 mm more preferably. Heat insulating member 15 is disposed in the region equal to or smaller than 5% of the total area of wall surface 13a. The configuration having small heat insulating member 15 disposed on a part other than wall surfaces 13a* to an extent in which heat insulating property is not affected is equivalent to this configuration.

When battery case 12 is made of aluminum, the thickness of heat insulating member 15 preferably ranges from 0.3 mm to 0.7 mm inclusive. Heat insulating member 15 and air layer 16 have an equal thickness. Thus, in other words, thickness t₁₆ of air layer 16 is set within the above range. When thickness t₁₆ is within the above range, thermal runaway can be efficiently prevented while heat equalization of individual batteries 11 in normal use is not affected. Preferable thickness t₁₆ can be obtained by the simulation to be described in a second exemplary embodiment, for example.

Battery module 10 having the above configuration can equalize the heat of individual batteries 11 in normal use. At the same time, when abnormal heat generation is caused in part of batteries 11 by an internal short circuit, for example, the thermal effect on normal batteries 11 can be reduced. That is, the use of battery case 12 formed of a material having excellent thermal conductivity, such as aluminum, can reduce temperature variations of individual batteries 11 in normal use. Disposing heat insulating members 15 between wall surfaces 13a of holding parts 13 and batteries 11 can reduce transfer of the heat generated in part of batteries 11 to other batteries, thereby preventing thermal runaway.

In battery module 10, even when abnormal heat generation is caused in part of batteries 11, other normal batteries 11 are operable and thus the system shutdown can be prevented. Since heat insulating member 15 is a small component disposed between wall surface 13a of holding part 13 and battery 11, thermal runaway can be prevented while the size of the module is not increased.

Especially, disposing heat insulating members 15 on wall surfaces 13a* only so that an air layer is formed between wall surface 13a and battery 11 can reduce the above thermal effect more efficiently.

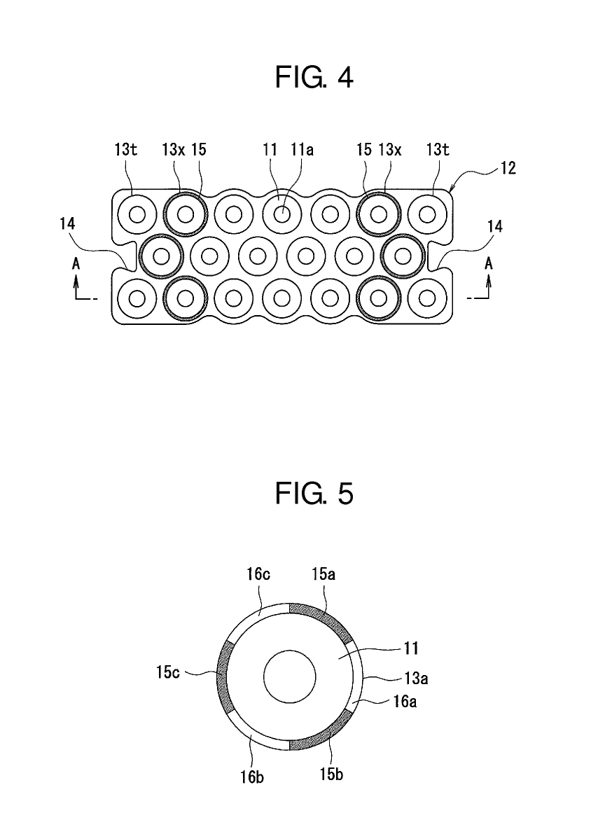

In the above description, heat insulating members 15 are disposed in all holding parts 13, but may be disposed in part of holding parts 13 as shown in FIG. 4. In the example shown in FIG. 4, heat insulating member 15 is disposed only in each of second holding parts 13x that are adjacent to first holding parts 13t positioned at the outermost ends of holding parts 13. In this case, the diameter of second holding part 13x is set larger than the diameters of other holding parts 13. Each of first holding parts 13t is positioned at the outermost ends of individual holding parts 13 and has the minimum number of adjacent holding parts 13 (holding parts 13x). Thus, when abnormal heat generation is caused in battery 11 held in first holding part 13t, heat dissipation is insufficient, which increases the thermal effect on battery 11 held in second holding parts 13x adjacent to the first holding part. For this reason, it is preferable to dispose heat insulating members 15 in second holding parts 13x. Disposing heat insulating members 15 only in second holding parts 13x can efficiently perform both of the heat equalization of individual batteries 11 in normal use and the prevention of thermal runaway.

In the above description, ring-shaped heat insulating member 15 is shown as an example. As shown in FIG. 5 (a diagram of one holding part 13 holding battery 11 as viewed from the top), a plurality of heat insulating members 15a, 15b, 15c may be disposed at an interval along the circumferential direction of battery 11. Heat insulating members 15a, 15b, 15c are disposed at a substantially equal interval along the circumferential direction of battery 11. Namely, in the example shown in FIG. 5, even in the portions including the heat insulating member, air layers 16a, 16b, 16c can be formed along the circumferential direction of battery 11. This can reduce the installation area of the heat insulating members and increase the area of air layers, thereby enhancing the heat insulating function.

### Second Exemplary Embodiment

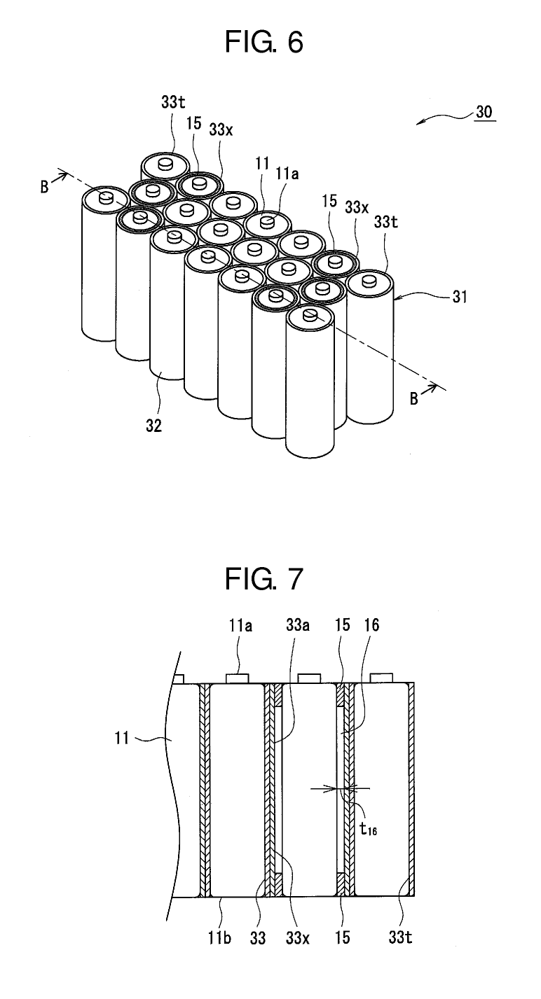

Each of FIG. 6 and FIG. 7 shows battery module 30 in accordance with the second exemplary embodiment. FIG. 6 is a perspective view of battery case 31 that holds batteries 11. FIG. 7 is a drawing showing part of a section taken along BB line of FIG. 6. In the following description, elements common to those of the first exemplary embodiment have the same reference marks, the description of the elements is omitted, and differences from the first exemplary embodiment are detailed.

Battery module 30 differs from that of the first exemplary embodiment in that the battery module includes battery case 31 instead of battery case 12. Battery case 31 is configured by combining a plurality of metallic pipes 32. For instance, plurality of metallic pipes 32 is welded to each other and forms one battery case 31. Similarly to battery module 10, battery module 30 includes connecting members and insulating members for positive and negative electrodes. However, because battery case 31 is used, the forms of the elements on the periphery of the case are slightly different from those in the case of battery module 10.

Similarly to battery case 12, battery case 31 has 20 independent holding parts 33. The inside of each of metallic pipes 31 works as holding part 33 for holding battery 11. Namely, battery case 31 is configured of 20 metallic pipes 32. Similarly to battery case 12, battery case 31 has holding parts 33 in three lines in the width direction of the case and holding parts 33 in adjacent lines are arranged in a hound's-tooth (a staggered (zigzag)) pattern.

Heat insulating members 15 are disposed only in part of holding parts 33. Specifically, similarly to the example shown in FIG. 4, heat insulating members 15 are disposed only in second holding parts 33x that adjoin first holding parts 33t positioned at the outermost ends of holding parts 33. Heat insulating member 15 is disposed on wall surface 33a of second holding part 33x only at each of both longitudinal ends, and air layer 16 is formed between wall surface 33a and battery 11.

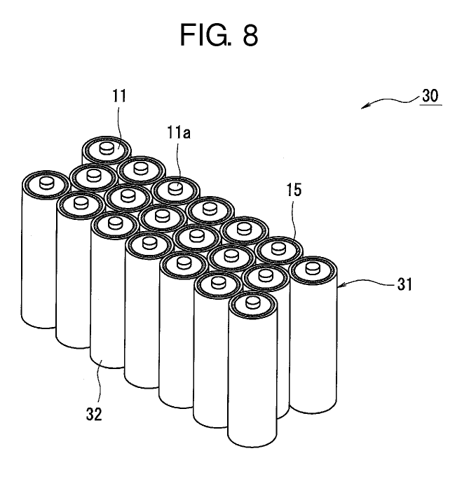

Also in the second exemplary embodiment, as shown in FIG. 8, heat insulating members 15 may be disposed in all holding parts 33. Air layers 16 may be disposed in all holding parts 33 so that heat insulating member 15 is disposed on each wall surface 33a only at each longitudinal end thereof.

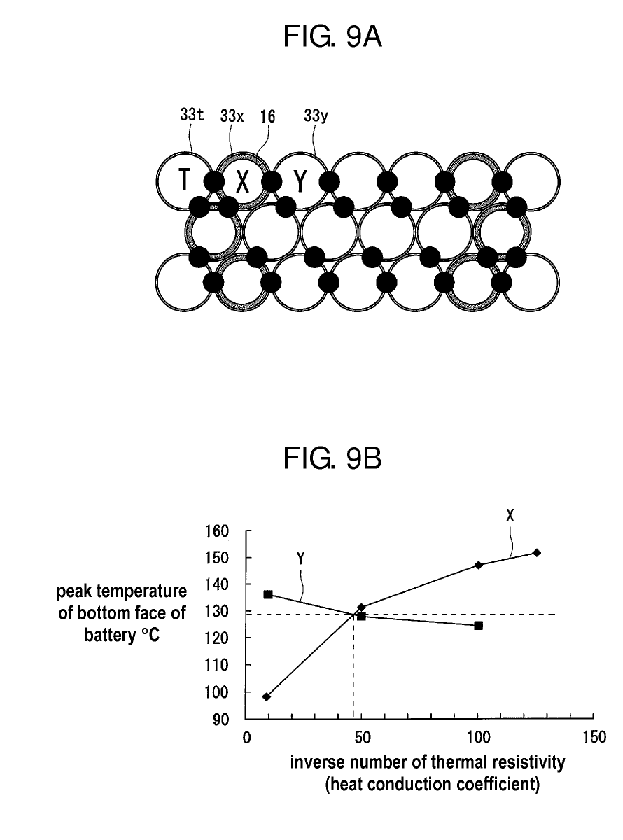

Here, the preferable thickness of air layer 16 is detailed with reference to FIG. 9A and FIG. 9B. FIG. 9A is a diagram showing a case where battery T held in first holding part 33t in battery case 31 abnormally generates heat. In FIG. 9A, welded points are shown by black circles. FIG. 9B is a graph showing a relation between peak temperatures on the bottom faces of battery X and battery Y and an inverse number of a thermal resistivity in second holding part 33x that holds battery X when battery T abnormally generates heat.

The preferable thickness t₁₆ of air layer 16 can be obtained by the following simulation. In this simulation, suppose that battery T abnormally generates heat and high-temperature gas is generated. Then, the peak temperatures of the bottom faces of battery X and battery Y (parts of negative electrode terminals 11b) are calculated to provide thickness t₁₆. Battery X adjacent to battery T is held in second holding part 33x (hereinafter being referred to as a “catching fire preventing holding part”). Battery Y held in holding part 33y that adjoins the catching fire preventing holding part and not adjoins first holding part 33t is held in a holding part in which no air layer 16 is formed.

Preferably, thickness t₁₆ is set so that the temperatures of battery X and battery Y are equal to each other. As shown in FIG. 9B, when the thermal resistivity of the catching fire preventing holding part is set to approximately 1/50 m²K/W, the temperatures of battery X and battery Y are equal to each other. To achieve the above thermal resistivity, thickness t₁₆ of air layer 16 needs to be set to 0.5 mm when the installation area of heat insulating member 15 is small and thus thermal conduction through heat insulating member 15 can be neglected. Namely, in this model, thickness t₁₆ is preferably set to 0.5 mm. When the temperatures of battery X and battery Y are set equal to each other, the heat equalization in normal use and the prevention of thermal runaway can be efficiently performed at the same time.

This simulation can be performed, using commercially available fluid analysis software. Preferable software includes Fluent (from ANSYS) and CFdesign (from CFdesign). The information necessary for this simulation is roughly classified into the following material parameters and border parameters. In this simulation, the calculation is performed by changing the contact thermal resistance between batteries and a case described below, and thickness t₁₆ is obtained based on the above viewpoint. A value of 1/125 [W/m²K] is equal to 0.2 mm in terms of the thickness of the air layer.

### <Material Parameters>

Battery; specific heat, thermal conductivity, and density
Battery case; specific heat, thermal conductivity, and density
Contact thermal resistance; between batteries and case, and between metallic pipes

### <Border Parameters>

Heat generation conditions of battery (relation between amount of heat generation and time); obtained by actual evaluation
Thermal conductivity of top face, i.e. gas discharging face, of battery case (heat radiation conditions); calculated from preliminary simulation using gas generation conditions obtained by actual evaluation and other parameters
Heat transfer coefficient (heat radiation conditions, thermal conductivity) of side face of battery case; appropriately set under installation conditions of case
Heat transfer coefficient (heat radiation conditions, thermal conductivity) of bottom face of battery case; appropriately set under installation conditions of case

### Third Exemplary Embodiment

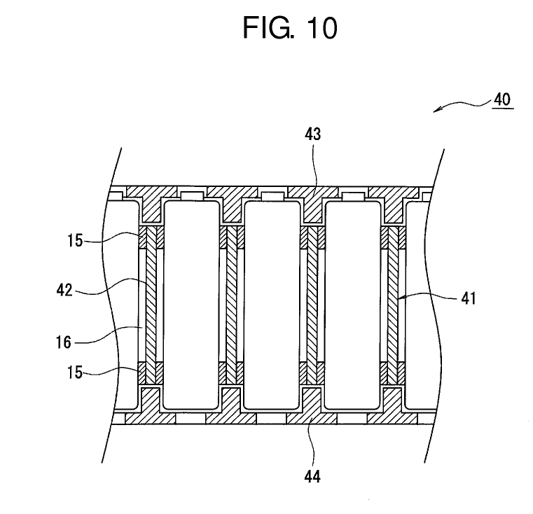

FIG. 10 shows battery module 40 in accordance with the third exemplary embodiment.

FIG. 10 is a sectional view of battery module 40 taken along the axial direction of battery 11, and corresponds to each of FIG. 3 and FIG. 7.

Battery module 40 differs from that of the first exemplary embodiment in that the battery module includes battery case 41 instead of battery case 12. In battery case 41, the length of holding part 42 (longitudinal length) is shorter than the axial length of battery 11. Thus, battery 11 protrudes from holding part 42 at both ends of holding part 42. Because of such a difference, each of insulating members 43, 44 has projections for surrounding the portions where corresponding batteries protrude from holding parts 42. In other words, each of insulating members 43, 44 has a plurality of recesses capable of receiving axial ends of corresponding batteries 11. In this exemplary embodiment, each of insulating member 43, 44 functions as a holding member for covering the axial ends of corresponding batteries 11. As the connecting members for each electrode, those similar to the connecting members of the first exemplary embodiment can be used.

Also in this case, the shape and hole-diameter of holding part 42 are identical with those of holding part 13. Heat insulating member 15 is disposed between wall surface 42a of holding part 42 and battery 11, and air layer 16 is formed between wall surface 42a and battery 11. However, the following configuration is preferable in battery module 40. In consideration of the heat transfer through insulating members 43, 44, the installation area of heat insulating members 15 is made smaller than that of the first exemplary embodiment, so that the area of air layers 16 is increased.

1. A battery module comprising:
a plurality of batteries; and
a metallic or ceramic battery case that includes holding parts holding the corresponding batteries,
wherein a heat insulating member is disposed between a wall surface of each of the holding parts and corresponding one of the batteries, and
the heat insulating member is disposed in a part between the wall surface of the holding part and the battery so that an air layer is formed between the wall surface and the battery.

2. The battery module of claim 1, wherein the heat insulating member has a thermal conductivity lower than that of the battery case, is a solid at 300° C., and has a thermal decomposition start temperature equal to or higher than 300° C.

3. The battery module of claim 1, wherein the heat insulating member is disposed on the wall surface only at each of both longitudinal ends of the holding part.

4. The battery module of claim 1, wherein the heat insulating member is only disposed in a second holding part adjacent to a first holding part to which a minimum number of the holding parts are adjacent.

5. The battery module of claim 1, wherein the battery case is made of aluminum, and a thickness of the heat insulating member ranges from 0.3 mm to 0.7 mm inclusive.

6. The battery module of claim 4, wherein a thickness of the heat insulating member is set so that when the battery held in the first holding part abnormally generates heat, temperatures of the battery held in the second holding part and the battery in the holding part adjoining the second holding part except the first holding part are substantially equal to each other.

7. The battery module of claim 1, wherein the heat insulating member is made of polyimide.

8. The battery module of claim 1, wherein
a longitudinal length of the holding part is shorter than an axial length of the battery, and
a holding member in which recesses for receiving axial ends of the corresponding batteries are formed is disposed.
